(19) United States
(12) Patent Application Publication
(10) Pub. No.: US 2005/0268268 A1
(43) Pub. Date: Dec. 1, 2005

(54) Methods and systems for structured ASIC electronic design automation

(75) Inventors: Teng-I Wang, Cupertino, CA (US); Zhong-Qing Shang, Cupertino, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Tera Systems, Inc., San Jose, CA (US)

(21) Appl. No.: 11/140,915

(22) Filed: Jun. 1, 2005

Related U.S. Application Data
(60) Provisional application No. 60/575,422, filed on Jun. 1, 2004.

(51) Int. Cl. G06F 9/45

(52) U.S. Cl. 716/9; 716/7

(57) ABSTRACT

Electronic design automation (“EDA) methods and systems for structured ASICs include accessing or receiving objects representative of source code for a structured ASIC. The objects are flattened to remove hierarchies associated with the source code, such as functional RTL hierarchies. The flattened objects are clustered to accommodate design constraints associated with the structured ASIC. The clustered objects are floorplanned within a design area of the structured ASIC. The objects are then placed within the portions of the design areas assigned to the corresponding clusters. The objects optionally include logic objects and one or more memory objects and/or proprietary objects, wherein the one or more memory objects and/or proprietary objects are placed concurrently with the logic objects.

### CROSS-REFERENCE TO RELATED APPLICATIONS

The present invention claims the benefit of U.S. Provisional Application No. 60/575,422, filed Jun. 1, 2004, which is hereby incorporated by reference in its entirety.

### BACKGROUND OF THE INVENTION

1. Field of the Invention

The invention relates to electronic design automation and, more particularly, to structured ASIC design.

2. Related Art

Integrated circuits are designed using computer-based hardware description languages (“HDLs”), which are analogous to computer program source code. Electronic design automation (“EDA”) tools are used to reduce the HDL code to actual integrated circuit designs. The integrated circuit designs can then be fabricated into integrated circuits. Reduction of HDL code to a circuit design is analogous to the reduction (i.e., compiling) of computer program source code to machine language code. EDA processes can “reduce” hundreds or thousands of lines of HDL code to millions of transistor gates and associated interconnections.

EDA tools typically attempt to optimize the design and layout of integrated circuit designs so that the designs meet speed, power, and/or other constraints. EDA processes tend to be extremely complex and consume substantial computational resources. A typical reduction process can take days, weeks, or even months.

Conventional EDA tools are useful for designing application specific integrated circuits (“ASICs”).

A new type of ASICs, referred to herein as “structured ASICs,” are designed with pre-fabricated integrated circuitry. Structured ASICs can be programmed relatively quickly. Because of the pre-fabricated integrated circuitry, however, structured ASICs are burdened with complex design constraints, such as clock usage constraints (e.g., a finite number of clocks available in a particular area) and component constraints (e.g., finite number of flip-flops or other devices within a particular area). The constraints must be considered when designing for structured ASICs.

What are needed, therefore, are improved EDA methods and systems for use with structured ASICs.

### SUMMARY OF THE INVENTION

The present invention is directed to methods and systems for electronic design automation (“EDA”) of structured ASICs. In an embodiment, objects are received that are representative of source code for a structured ASIC. The objects include one or more of standard cell objects, logic objects, memory objects, and/or IP objects.

The objects are flattened to remove hierarchies associated with the source code, such as functional RTL hierarchies.

The flattened objects are clustered to accommodate design constraints associated with the structured ASIC. The design constraints can include external constraints and/or implicit constraints. For example, and without limitation, the clustering can include clustering objects having similar clock usage requirements, limiting the numbers of similar objects in a cluster, clustering objects based on area or region constraints, and/or clustering objects based on one or more cloud constraints. The clustering optionally seeks to minimize the number of interconnections between the clusters.

The clustered objects are floorplanned within a design area of the structured The floorplanning optionally positions the clusters within the design area so as to minimize wire lengths between the clusters. Floorplanning is optionally implemented with simulated annealing.

The objects are then placed within the portions of the design areas assigned to the corresponding clusters.

The objects optionally include logic objects that include physical implementation information including placement-based wire load models, gate delay information, pin information, and/or mappings between objects and corresponding source code.

In an embodiment, memory objects and/or proprietary objects are placed based concurrently with other objects.

Additional features and advantages of the invention will be set forth in the description that follows. Yet further features and advantages will be apparent to a person skilled in the art based on the description set forth herein or may be learned by practice of the invention. The advantages of the invention will be realized and attained by the structure particularly pointed out in the written description and claims hereof as well as the appended drawings.

It is to be understood that both the foregoing summary and the following detailed description are exemplary and explanatory and are intended to provide further explanation of the invention as claimed.

### BRIEF DESCRIPTION OF THE DRAWINGS/FIGURES

The present invention will be described with reference to the accompanying drawings, wherein like reference numbers indicate identical or functionally similar elements. Also, the leftmost digit(s) of the reference numbers identify the drawings in which the associated elements are first introduced.

FIG. 1 is an example process flowchart for generating logic objects.

FIG. 2 is another example process flowchart for processing RTL using objects.

FIG. 3 is a block diagram of a structured ASIC 300.

FIG. 4 is a flowchart 400 of an example method of designing for a structured ASIC in accordance with the present invention.

### DETAILED DESCRIPTION OF THE INVENTION

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

I. Integrated Circuit Design Overview

Integrated circuits are designed using computer-based hardware description languages (“HDLs”). Several types of HDL exist, including but not limited to verilog, VHDL, systemC, SystemVerilog, and resistor transistor logic (“RTL”). Although the present application will describe the invention with reference to RTL code, a person of ordinary skill in the art will recognize that any type of logic source code may be used.

EDA tools are typically classified as front-end or back-end tools. Front-end EDA tools typically operate on HDL code and/or abstract representations of functions associated with the HDL code. Conventional front-end EDA tools attempt to optimize the HDL code and/or the abstract representations. For example, synthesis and technology mapping, functional verification, and/or initial timing analyses can be performed.

Conventional front-end EDA tools utilize rough estimates or statistical estimations of characteristics of the eventual integrated circuit design. The characteristics can include timing and/or power consumption. Because of the rough estimates, conventional front-end processes are less than ideal, but can be useful, nevertheless, because they can identify some problems at an early stage.

During back-end processing, the HDL code and/or abstract objects representative of the HDL code are converted to a layout design of the integrated circuit. A typical layout design includes millions of gates and associated interconnections. The back-end processing arranges and re-arranges the gates in an attempt to obtain desired operational characteristics. This is often referred to as a “place and route” operation. Because of the sheer number of gates and interconnections, conventional back-end processing typically takes days to converge on a solution.

In many cases, the initial back-end operation is unable to obtain or converge on a design that meets the design criteria (i.e., desired operational characteristics). For example, the circuit may consume more power than called for, or may have internal gate or wire delays, which prevent proper operation. When this occurs, designers must revise the HDL code and repeat the front-end and back-end processes. EDA thus tends to be an iterative process, which may take days, weeks, or months to converge on a workable design.

Additional features related to front-end and back-end processing are provided below.

A. Front End: RTL and Synthesis

Integrated circuit designers write desired functionality into RTL code. During front-end design, the RTL code is converted, or synthesized, to a gate-level list (“gate-level netlist”) of transistor gates (“gates”) and interconnections. Synthesis typically includes optimization of the RTL code, such as by elimination of redundant terms. Synthesis can also revise the structure of the RTL code to improve performance.

Some conventional synthesis tools use models for certain types of logic, such as adders and multipliers. Conventional systems do not, however, utilize the models for placement operations and do not use actual physical information in the models (e.g., actual wire lengths and gate delay information). Thus, gate-level netlists generated by conventional synthesis systems typically require extensive additional optimization and iterations at the back end.

B. Back End: Place and Route

During back-end processing, the gate-level netlist is mapped onto an integrated circuit design. This includes iteratively rearranging the placement of the gates, and iteratively routing and re-routing interconnections so that the circuit meets given timing and power constraints. This typically involves placing the gates so as to minimize routing lengths, congestion, and other factors. Because of the sheer number of gates involved in typical designs, optimization procedures that are executed in the back end are typically very time consuming and computationally demanding. The back-end process also involves the floorplanning of macros, black boxes, and user defined blocks, as well as the placement of I/O pads. This process is typically very difficult, requiring a lot of manual intervention, and is generally not in the skill set of a typical front-end designer.

II. Advanced Optional Processing Features, Abstract Representations of RTL, and Physical Synthesis

In order to reduce the work required during back end processing, groups of associated gates are optionally represented as objects. The objects represent functionality encoded by the RTL. Traditional back-end optimization operations, such as, and without limitation, logic optimization, floorplanning, placement, and/or routing operations can be performed on the objects at a high level by the front-end designer. These optimization operations done at a high level of abstraction reduce the work required in the back end and thus reduce the overall time required to convert RTL code to an integrated circuit design.

For example, Tera Systems, Inc., of Campbell, Calif., has developed logic objects (e.g., Tera Systems' TeraGates™), that provide realistic high-level representations of integrated circuit building blocks. Tera Systems, Inc. has also developed a number of processes for optimizing design layouts of objects, including logic objects (e.g., Tera Systems' TeraForm™). The realistic high level representations and associated processes allow for more accurate front end and back end optimizations at a high level of abstraction. As a result, the amount of work performed during back-end processing is significantly reduced.

Logic objects represent RTL code, or portions thereof. Each logic object typically represents multiple gates, sometimes thousands of gates. Logic objects can represent, for example, AND functions, OR functions, and more complex functions such as adders, multipliers, and multiplexers. The logic objects serve as high-level or abstract representations of the integrated circuit design.

An important feature of the logic objects is that they include actual gate level physical information associated with the underlying gates. The physical information can include structural information for the underlying gates, placement-based wire-load models for wires between gates, related placement information for gates included in the model, and actual timing information for the gates. The gate level physical information is obtained from integrated circuit fabrication facilities. Libraries of logic objects can be generated to incorporate various design features that are supported by a fabrication facility.

Inclusion of physical information in the logic objects, including use of placement-based wire-load models, and associated processes, are described in U.S. Pat. Nos. 6,145,117 and 6,360,356B1, and U.S. patent application Ser. No. 10/040,852, all titled, “Creating Optimized Physical Implementations from High-Level Descriptions of Electronic Design,” all of which are incorporated herein by reference in their entireties.

In operation, during front-end processing, RTL code, or portions thereof, is automatically converted to logic objects and other optional objects. The objects are then placed and routed during front-end processing.

Advanced front-end operations are performed on hundreds or thousands of logic objects and other types of optional objects, rather than the millions of gates that are operated on during back-end processing. Advanced front-end operations for processing logic objects include floorplanning, place and route operations, which take into account the actual physical information of the underlying circuitry that is represented by the logic objects.

Advanced front-end processing of objects essentially move back-end operations to the front-end. At the same time, the product automates these back-end operations to make the tool usable and accessible to conventional front-end designers, without requiring the years of experience that conventional back-end tools require for effective usage. As a result, design problems are more likely to be identified early on by the actual system designers instead of late in the design flow by the back-end engineering team. In addition, when the advanced front-end process converges on a place and route solution for the objects, the back-end process simply has to place and route gates within the area that was assigned to corresponding logic objects. In other words, there is generally no need for iterative back-end place and route operations to be performed on the overall design. Thus, back-end processing can typically be performed in a single pass.

When the advanced front-end synthesis process is performed with actual physical information, the synthesis operation is referred to herein as a “physical synthesis” operation. The front-end physical synthesis operation generates a netlist of objects rather than a gate level netlist. The netlist of objects includes gatelist information associated with each object that is needed during back-end processing. Since the objects have been placed during front-end processing, back-end processing can focus on detailed placement of the gates within each object. This substantially reduces the amount of work performed during back-end processing.

The objects optionally include information that maps the objects back to the corresponding RTL code. As a result, debugging of a design, at any level, can be mapped back to the corresponding RTL code.

RTL code can be converted into a variety of types of objects, examples of which are provided below. The invention is not, however, limited to the examples provided herein. Based on the description herein, one skilled in the relevant art(s) will understand that other types of objects can be utilized, and that objects may be of multiple types.

Objects, such as logic objects, allow the RTL code to be represented at a level of abstraction that is above a gate level netlist. The objects can be manipulated during front-end processing using fewer resources (e.g., computational resources and/or manpower resources) than what is required to manipulate corresponding gate level components.

For example, placement operations are optionally performed on the objects. Front-end placement operations provide placement information for the objects. During back-end processing, gates within the abstract objects are placed within the areas assigned to corresponding objects. Front-end operations performed on abstract objects are relatively fast because there are fewer objects to manipulate, compared to the number of gate level components in a netlist. The high-level operations thus reduce the overall time to reduce RTL code into an integrated circuit design.

A. Standard Cell Objects

Some portions of RTL code provide support functions for other features. Support functions can include, without limitation, glue logic, timing logic, control logic, memory logic, interconnection, etc. The term glue logic is used to broadly refer to features such as, and without limitation, buffers and/or interfacing functions. RTL code that provides such supporting functions is optionally represented as objects referred to herein as standard cell objects. A standard cell object may be an abstraction representing one or more transistors or gates, such as AND gates and OR gates.

A standard cell object may include information such as, and without limitation, function(s) performed by the standard cell, area required to implement the standard cell, interconnections with other objects, and/or identification of the line(s) of RTL code that are associated with the standard cell.

B. Logic Objects

Some portions of RTL code are typically directed to more complex logical functions, such as AND operations, OR operations, multiplying operations, multiplexing operations, and sequential (flip-flop, latch) operations. Such RTL code is optionally represented by what is referred to herein as TeraGates™ or logic objects. A logic object is an abstraction that typically represents multiple gates and/or standard cells.

Logic objects include actual gate level physical information associated with the underlying gates, as described above. Logic objects also include information such as, and without limitation, function(s) performed by the logic object, area required to implement the logic object, interconnections with other objects, and/or identification of the line(s) of RTL code that are associated with the logic object.

C. Memory and IP Blocks

A typical integrated circuit design includes one or more memory blocks and/or one or more proprietary blocks. Proprietary blocks are often referred to as intellectual property blocks or IP blocks. Memory blocks and proprietary blocks are optionally represented as objects during front-end processing.

D. Hierarchies

Designers often write RTL code with hierarchies, in which functions are grouped together according to some principle, such as according to an associated engineering group responsible for the code, and/or according to functions performed by the associated code. RTL functional hierarchies, and/or other hierarchies described below, are optionally maintained during synthesis.

In the actual layout of the integrated circuit, it may make more sense to re-group components from one hierarchy to another in order to optimize timing, routing, area, and/or power requirements. In some situations, therefore, functional RTL hierarchy designations are dissolved or ignored, in whole or in part, during front-end and/or back-end processing. The underlying logic encoded in the RTL is not ignored, only the grouping of logic functions.

E. Hard Objects, Pseudo Hard Objects, and Soft Objects

Objects are optionally defined as hard objects, pseudo hard objects, or soft objects. Hard objects have fixed shape constraints. Pseudo hard objects have one or more discrete shape constraints. Soft objects, on the other hand, have no shape constraints.

Standard cell objects, memory, and IP blocks typically have fixed size and/or shape and are thus generally referred to as hard objects. Logic objects and hierarchies typically have variable size and/or area constraints and are thus considered soft objects. Hierarchies (logic functions or clusters) which contain hard and/or pseudo hard objects are considered pseudo hard objects.

III Example Environment for RTL Processing with Logic Objects

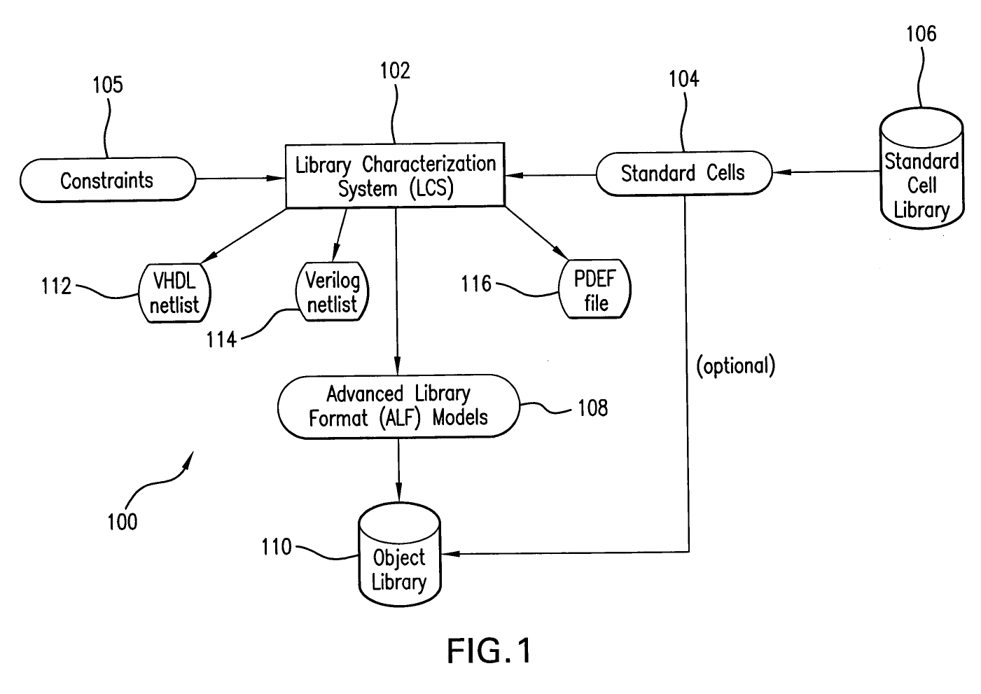

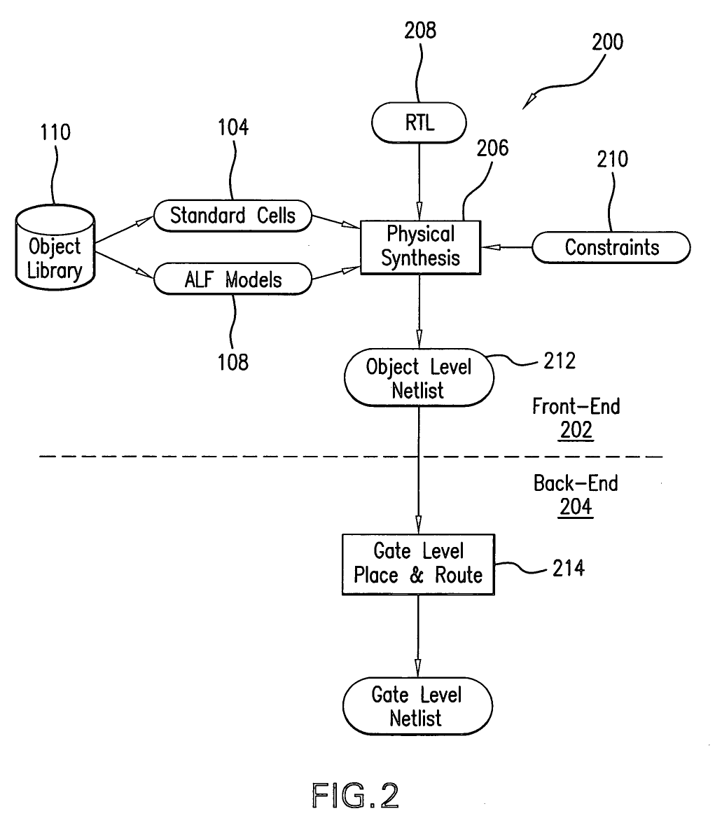

FIGS. 1 and 2 are example process flowcharts according to embodiments of the invention for processing RTL using logic objects. The invention is not, however, limited to the examples of FIGS. 1 and 2. Based on the description herein, one skilled in the relevant art(s) will understand that the invention can be implemented with other process flowcharts.

A. Generation of Libraries of Logic Objects

FIG. 1 is a process flowchart 100 for generating logic objects. A library characterization system (“LCS”) 102 receives standard cells 104 from a library of standard cells 106. The standard cells 104 typically include a plurality of standard logic cells such as, for example and without limitation, AND cells, OR cells, flip-flops, and the like. The standard cells 104 are optionally obtained from an integrated circuit fabrication facility, wherein the standard cells 104 incorporate process-dependent features of the fabrication facility, including timing, physical area, and power information.

The LCS 102 also receives constraints 105. The constraints 105 include gate level physical information for implementing the standard cells 104. The constraints 105 are typically associated with a fabrication facility and, more particularly, with an implementation technology of the fabrication facility. For example, and without limitation, the constraints 105 are optionally tailored for speed, power consumption, and/or process, voltage, and/or temperature operating ranges.

The LCS 102 generates, from standard cells 104 and in accordance with constraints 105, advanced library format (“ALF”) models 108, VHDL netlist 112, Verilog netlist 114, and PDEF file 116. VHDL netlist 112 and Verilog netlist 114 may be used to provide a complete gate-level netlist to back-end tools. This precludes the need to run a separate gate-level synthesis in order to provide a full netlist to the back-end. PDEF file 116 includes relative placement information, which can be used to drive the detailed placement of back-end tools. This improves overall correlation with back-end tools. The ALF models 108 represent, for example and without limitation, one or more of the standard cells 104, and/or more complex logic, such as multipliers, multiplexers, Boolean logic or glue logic, and/or mega functions such as large adders, that are constructed from multiple standard cells 104.

The ALF models 108 include a variety of information such as a listing of physical gates needed to implement the logic object, pin information associated with the gates, interconnection information between the gate pins, bit widths, architecture, constraints used to build the object, detailed timing information, detailed area information, and/or other physical information, such as placement-based wire load models.

The ALF models 108 are stored in an object library 110. The object library 110 optionally includes one or more standard cells 104, with or without physical information.

The library 110 is optionally generated, in whole or in part, in advance of need and/or on-the-fly. The libraries can also contain a description of the relative placement of gates within the object, which can be used to drive downstream back-end implementation tools. Multiple libraries 110 can be generated for different technologies using different sets of constraints 105.

B. Physical Synthesis Using Libraries of Logic Objects

FIG. 2 is a process flowchart 200 for synthesizing RTL code using logic objects. The process flowchart 200 includes a front-end processing section 202 and a back-end processing section 204.

A physical synthesis module 206 receives RTL code 208, ALF or logic object models 108 from object library 110, and constraints 210. The constraints 210 are for the design in process and are not the same as constraints 105 in FIG. 1. The physical synthesis module 206 optionally receives one or more standard cells 104.

The physical synthesis module 206 synthesizes the RTL code 208 using the ALF models 108 and the constraints 210. The physical synthesis module 206 optionally uses one or more standard cells 104. Physical synthesis includes traditional RTL synthesis as well as floorplanning, placement, and/or routing of the objects using physical information associated with the ALF models 108.

During synthesis, the physical synthesis module 206 generates instances of the ALF models 108 (i.e., logic objects) as needed to represent functionality encoded in the RTL 208. Each instance of a logic object retains most, if not all, of the information originally contained within the corresponding ALF model 108.

Each instance of a logic object is populated with an identification of the portion(s) of the RTL code 208 associated with the instance of the logic object. Each instance of the logic object is further populated with interconnection information to other objects. Thus each instance of a logic object includes gate level netlist information, timing and area information, and mapping information to corresponding RTL code. The RTL netlist mapping information allows the objects to be mapped back to the RTL for troubleshooting and/or other purposes.

During physical synthesis, the physical synthesis module 206 optionally performs one or more conventional synthesis operations on the RTL code 208. Since each object represents multiple gates, manipulations of the objects takes considerably less computer processing time than would be required to perform similar manipulations of the individual gates at the back end.

During physical synthesis, the physical synthesis module 206 also optionally performs one or more unconventional synthesis operations on the RTL code 208, such as optimizing stacked logic. Stacked logic can be, for example, a bus of data lines that are ANDed together. Rather than generating a large number of small individual AND gates at the gate level, a single stacked, multiple input AND gate is used. The single stacked AND presents a single object to the tools, substantially improving the runtime and capacity. All of the process operating at this higher level of abstraction take advantage of this more advanced and efficient data model.

The physical synthesis module 206 outputs an object level netlist 212, which includes instances of logic objects generated by the physical synthesis module 206. Each logic object includes associated gate level netlist information. The object level netlist 212 is passed to the back-end process 204, where place and route operations are performed on the gate level netlist information associated with the logic objects. This gate level netlist can be provided, for example, by LCS 102.

IV. Structured ASIC Design

Structured ASICs are designed with pre-fabricated integrated circuitry. Structured ASICs can be programmed relatively quickly. Because of the pre-fabricated integrated circuitry, however, structured ASICs are burdened with complex design constraints such as clock usage constraints (e.g., a finite number of clocks available in a particular area) and component constraints (e.g., finite number of flip-flops or other devices within a particular area).

The present invention is directed to methods and systems for electronic design automation for structured ASICs, including methods and systems for considering structured ASIC constraints.

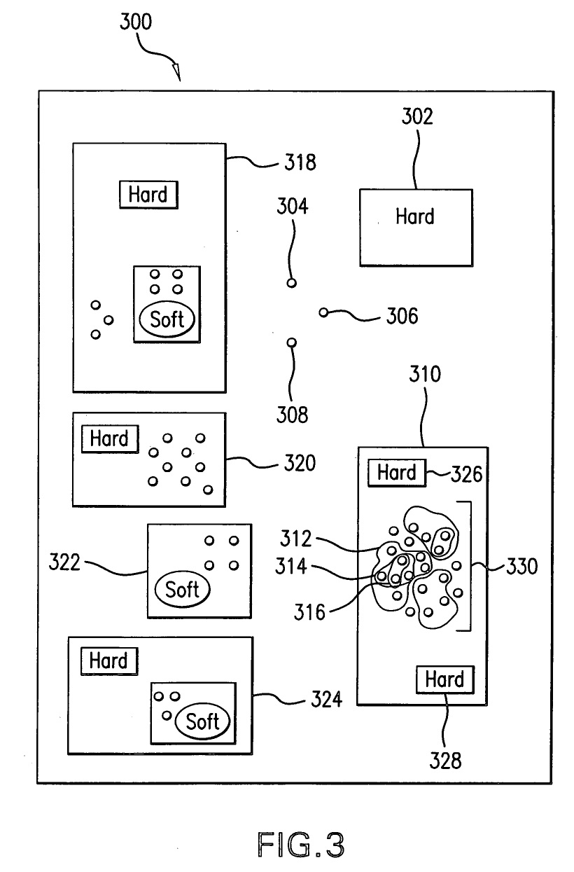

FIG. 3 is a block diagram of an example structured ASIC 300. The ASIC 300 is pre-fabricated with input/output (“I/O”) ports 302 and a core area 304. The core area 304 includes pre-fabricated features that can be selected for use in an ASIC design. For example, and without limitation, the core area 304 can provide one or more different clock networks, and a finite number of different types of integrated circuit components within specified areas of the core area 304.

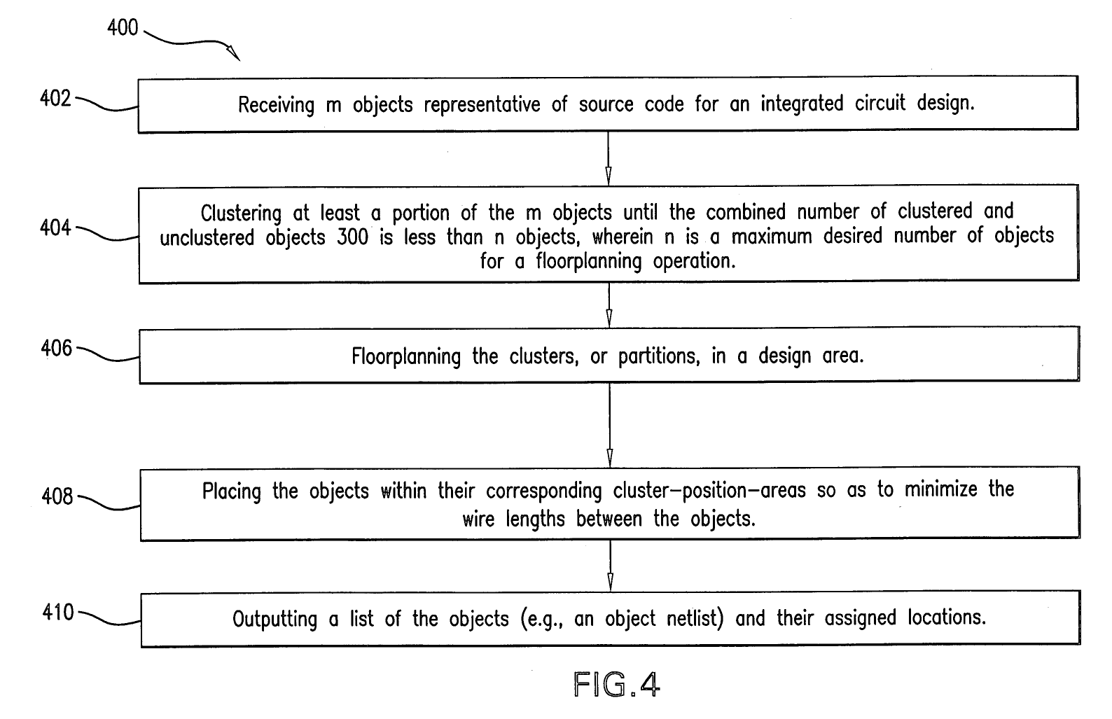

FIG. 4 is a flowchart 400 of an example method of designing for a structured ASIC, such as ASIC 300. The invention is not, however, limited to the examples herein. Based on the description herein, one skilled in the relevant art(s) will understand that the invention can be implemented in other ways.

Step 402 includes receiving objects representative of source code for the structured ASIC. The objects include one or more of standard cell objects, logic objects, memory objects, and/or proprietary objects. The logic objects include physical implementation information such as placement-based wire load models, gate delay information, pin information, and/or mappings between objects and corresponding source code.

Step 404 includes flattening the objects to remove hierarchies associated with the source code, such as functional RTL hierarchies.

Step 406 includes clustering the flattened objects to accommodate design constraints associated with the structured ASIC. Clustering utilizes one or more types external and/or implicit constraints. For example, and without limitation, the clustering includes clustering objects having similar clock usage requirements, and/or clustering finite numbers of similar objects. The clustering optionally seeks to minimize the number of interconnections between the clusters. The clustering optionally utilizes region constraints, which specify that certain objects can only be placed at certain areas or regions.

The above described constraints are typically imposed by a structure definition associated with the structured ASIC. Structure definitions typically vary by vendor.

The above described constraints are referred to herein as external constraints. Additionally, or alternatively, clustering involves internal constraints such as cloud constraints, which are now described.

Cloud constraints produce timing related clusters under the guidance of a synthesis hierarchy. A synthesis hierarchy is generated during synthesis of the source code (e.g., RTL code). Synthesis is optionally performed prior to step 402 to generate the objects received in step 402. Backend operations, such as floorplanning and placement, work directly upon a physical hierarchy representation associated with the objects received in step 402. The physical hierarchy is derived from the synthesis hierarchy. The physical hierarchy can be flat or multi-level. The physical hierarchy is not necessarily identical to the synthesis hierarchy. If the physical hierarchy is too distorted (e.g., synthesis nodes can get mixed up after flattening portions of a design), then the original hierarchy signature is transformed into a “cloud constraint,” which can then be used to influence the clustering process. Cloud constraints are thus based on circuit designs rather than structure definitions of an ASIC vendor. Cloud constraints are thus referred to herein as implicit constraints.

The number of cloud constraints used during clustering can vary, but generally depends upon the synthesis hierarchy. There is not necessarily a one-to-one to-one mapping between cloud constraints and clusters. The clustering process generally sets different thresholds for different invokers based on all constraints imposed. Thus, there can be multiple clusters of the same cloud constraint where other types of constraints prevent the clusters from being further merged.

High level modeling aspects of the invention permit logic, synthesis, and physical hierarchy to be maintained simultaneously, wherein the synthesis hierarchy is used to guide the clustering process of backend operations.

Step 408 includes floorplanning the clustered objects within a design area of the structured ASIC, such as core area 304 (FIG. 3). The floorplanning positions the clusters within the design area so that the clusters fit within the design area. The floorplanning optionally positions the clusters within the design area so as to minimize wire lengths between the clusters. Floorplanning is optionally implemented with simulated annealing.

Step 410 includes placing the objects within the portions of the design area assigned to the corresponding clusters.

Step 412 includes outputting a list of the objects and their assigned locations. The list of the objects is optionally converted to a gate level netlist. The gates within the netlist are then assigned “legal” positions within the design area. The legal positions are positions which meet design rules associated with the structured ASIC.

### Conclusions

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

1. A computer implemented method for designing structured application specific integrated circuits (“structured ASICs”), comprising:
accessing objects representative of source code for a structured ASIC;
flattening the objects to remove hierarchies associated with the source code;
clustering the flattened objects to accommodate design constraints associated with the structured ASIC;
floorplanning the clustered objects within a design area of the structured ASIC; and
placing the objects within the design areas assigned to the corresponding clusters.

2. The method according to claim 1, wherein the clustering step comprises clustering under control of one or more external constraints.

3. The method according to claim 2, wherein the clustering step comprises clustering objects having similar clock usage requirements.

4. The method according to claim 2, wherein the clustering step comprises clustering a limited numbers of similar objects within a cluster.

5. The method according to claim 2, wherein the clustering step comprises clustering according to one or more region constraints.

6. The method according to claim 2, wherein the clustering step comprises clustering objects having similar clock usage requirements, clustering limited numbers of similar objects, and clustering according to one or more region constraints.

7. The method according to claim 1, wherein the clustering step comprises clustering under control an implicit constraint.

8. The method according to claim 7, wherein the implicit constraint comprises one or more cloud constraints.

9. The method according to claim 8, wherein the one or more cloud constraints produce timing-related clusters under guidance of a synthesis hierarchy.

10. The method according to claim 1, wherein the clustering step comprises clustering under control of one or more external constraints and one or more implicit constraints.

11. The method according to claim 10, wherein the clustering step comprises clustering objects having similar clock usage requirements, clustering limited numbers of similar objects, clustering according to one or more region constraints, and clustering under one or more cloud constraints.

12. The method according to claim 1, wherein the floorplanning step comprises simulated annealing.

13. The method according to claim 1, wherein the objects comprise logic objects, the logic objects including physical implementation information for gates associated with the logic objects.

14. The method according to claim 13, wherein the physical implementation information comprises placement-based wire load models, gate delay information, pin information, and mapping information that maps the logic objects to corresponding source code.

15. The method according to claim 1, wherein the objects further comprise one or more memory objects.

16. The method according to claim 1, wherein the objects further comprise one or more proprietary objects.

17. The method according to claim 1, wherein the objects further comprise one or more memory objects and one or more proprietary objects.

18. The method according to claim 1, further comprising:
outputting a list of the objects and their assigned locations; and providing the list of objects to a back-end electronic design automation tool that places the integrated circuits represented by the objects within the placement area of the corresponding objects.

19. The method according to claim 1, wherein the accessing step comprises receiving the objects.
